(19) United States
(12) Patent Application Publication
(10) Pub. No.: US 2016/0232595 A1
(43) Pub. Date: Aug. 11, 2016

(54) METHODS, SYSTEMS, AND COMPUTER READABLE MEDIA FOR PROCESSING AN ORDER WITH A START-START DEPENDENCY

(71) Applicant: Oracle International Corporation, Redwood Shores, CA (US)

(72) Inventors: Marc John Corlett, Bolton (CA); Xuan Ju, Richmond Hill (CA); Wen Cui, Mississauga (CA); Amir-Behzad Roshan-Pazhouh, Richmond Hill (CA); Weizhong Shen, Beijing (CN)

(21) Appl. No.: 14/619,906

(22) Filed: Feb. 11, 2015

(51) Int. Cl. G06Q 30/06

(52) U.S. Cl. CPC G06Q 30/0635

(57) ABSTRACT

Methods, systems, and computer readable media for processing an order with a start-start dependency are disclosed. According to one exemplary method, the method occurs at an order management server that implements an electronic order management system. The order management server includes at least one processor and a memory. The method includes storing an orchestration plan for fulfilling an electronic order for a good or service. The method also includes receiving a request for adding a first order element having a start-start dependency with a second order element in the orchestration plan. The method further includes in response to the request, modifying the orchestration plan to reflect the start-start dependency. The method also includes processing the order in accordance with the orchestration plan.

### TECHNICAL FIELD

The subject matter described herein relates to a computerized order management system. More particularly, the subject matter described herein relates to systems, methods, and computer readable media for processing an order with a start-start dependency.

### BACKGROUND

At present, computerized order management systems are being employed in a number of industries to conduct order entry and order fulfillment tasks. For example, order entry may involve the process of electronically receiving orders and entering the orders into an order management system. In this example, the entered orders may be stored as record entities within the order management system for subsequent electronically fulfillment. In many instances, orders can contain data regarding one or more products (e.g., goods and/or services), pricing of the one or more products, and one or more offers related to the one or more products. Likewise, order fulfillment may include electronically fulfilling the orders after the orders have been entered into the order management system.

Some computerized order management systems may generate an orchestration plan for each order. An exemplary orchestration plan may include information specifying functions for fulfilling an order, information for managing the sequence of those functions, and/or information for managing dependencies between those functions. For example, an orchestration plan may include order elements (e.g., actions, items, tasks, and/or groups of items and/or tasks) that represent individual products, services, and/or offers that need to be fulfilled and may include dependencies between these order elements.

Conventional computerized order management systems may support complete-to-start dependency relationships between order elements. For example, a complete-to-start dependency between a first order element and a second order element may indicate a relationship where the first order element is completed prior to starting the second order element. While complete-to-start dependency relationships may be beneficial for order processing, additional and/or different dependency relationships can be useful for accurately and/or efficiently orchestrating an order.

Accordingly, there exists a need for systems, methods, and computer readable media for processing an order with a start-start dependency.

### SUMMARY

Methods, systems, and computer readable media for processing an order with a start-start dependency are disclosed. According to one exemplary method, the method occurs at an order management server that implements an electronic order management system. The order management server includes at least one processor and a memory. The method includes storing an orchestration plan for fulfilling an electronic order for a good or service. The method also includes receiving a request for adding a first order element having a start-start dependency with a second order element in the orchestration plan. The method further includes in response to the request, modifying the orchestration plan to reflect the start-start dependency. The method also includes processing the order in accordance with the orchestration plan.

According to one exemplary system, the system includes at least one processor and a memory. The system also includes an order management server that implements an electronic order management system. The order management server is configured to store, in the memory of the order management server, an orchestration plan for fulfilling an electronic order for a good or service, to receive a request for adding a first order element having a start-start dependency with a second order element in the orchestration plan, in response to the request, to modify the orchestration plan to reflect the start-start dependency, and to process the order in accordance with the orchestration plan.

The subject matter described herein may be implemented in hardware, software, firmware, or any combination thereof. As such, the terms “function”, “engine”, “node” or “module” as used herein refer to hardware, software and/or firmware components for implementing the feature(s) being described. In one exemplary implementation, the subject matter described herein may be implemented using a non-transitory computer readable medium having stored thereon computer executable instructions that when executed by the processor of a computer cause the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a block diagram illustrating an exemplary architecture for order management system according to an example of the subject matter described herein;

FIG. 2 is a diagram illustrating exemplary orchestration plans according to an example of the subject matter described herein;

FIG. 3 is a diagram illustrating exemplary logic for determining inferred dependencies according to an example of the subject matter described herein;

FIG. 4 is a diagram illustrating exemplary inferred dependencies according to an example of the subject matter described herein; and

FIG. 5 is a flow chart illustrating an exemplary process for processing an order having a start-start dependency according to an example of the subject matter described herein.

### DETAILED DESCRIPTION

The subject matter described herein relates to methods, systems, and computer readable media for processing an order with a start-start dependency. In accordance with some aspects of the subject matter described herein, methods, mechanisms, and/or techniques for supporting start-start dependency relationships between order elements in an orchestration plan are provided. For example, an order management system or a related entity may generate an orchestration plan for fulfilling or completing an order. In this example, the orchestration plan may include a sequence of order elements (e.g., data constructs representing actions or groups of actions) for completing an order and dependencies, if any, between these order elements. To efficiently support real-world order scenarios, various dependency relationships between order elements may be necessary. In particular, an order management system or a related entity may support a start-start dependency indicating that two order elements (or actions therein) in an orchestration plan should start concurrently (e.g., simultaneously or almost simultaneously). For example, a start-start dependency may be used to indicate that a long-lived order element, e.g., workforce management, should start simultaneously or concurrently with another long-lived order element, e.g., facilities confirmation. By utilizing start-start dependencies, an order management system or a related entity can improve efficiency in order processing by specifying that some related order elements be started concurrently, thereby generating more efficient orchestration plans for various real-world scenarios having such related order elements.

In accordance with some aspects of the subject matter described herein, methods, mechanisms, and/or techniques for supporting revisions of an orchestration plan that includes a start-start dependency relationship between order elements are provided. For example, an order management system or a related entity may receive a request for revising an orchestration plan by adding an order element, removing an order element, and/or redoing an order element while implementing the orchestration plan. In this example, an order management system or a related entity may support the revision by determining inferred dependencies (e.g., dependencies determined based on logic and not defined by a system operator) between order elements associated with a revised orchestration plan. By generating inferred dependencies, an order management system or a related entity can improve efficiency in performing revisions and/or generating a revised orchestration plan since a system operator may not need to identify every possible dependency relationship that may or does occur during a revision.

Reference will now be made in detail to exemplary embodiments of the presently disclosed subject matter, examples of which are illustrated in the accompanying drawings. Wherever possible, the same reference numbers will be used throughout the drawings to refer to the same or like parts. Various embodiments of the present subject matter are disclosed and described herein.

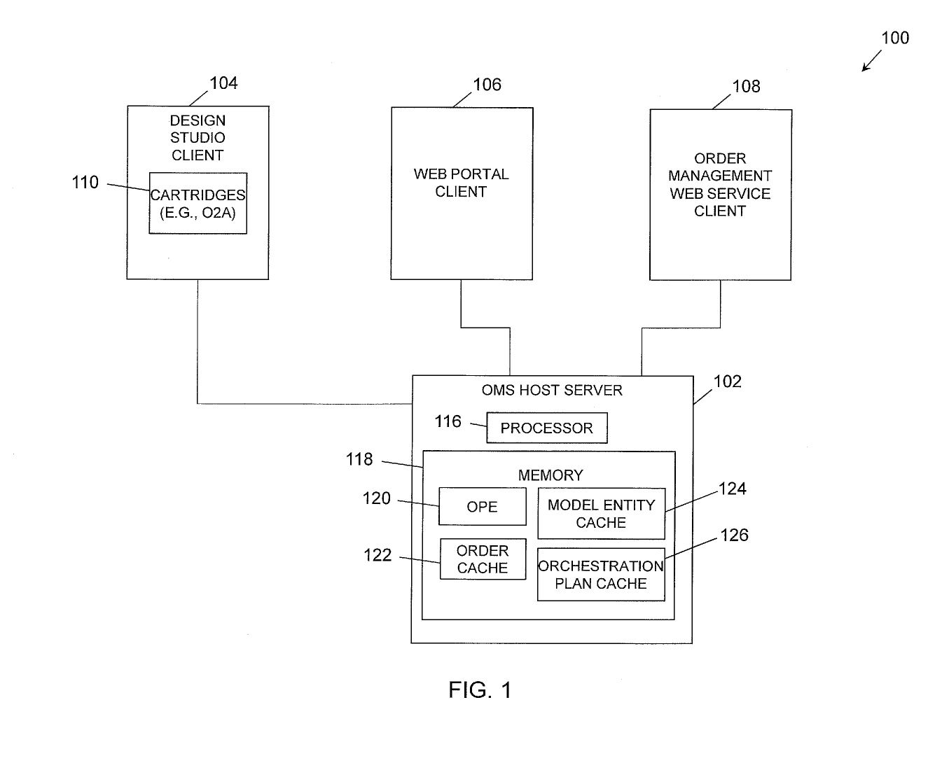

FIG. 1 is a block diagram illustrating an exemplary architecture for an order management system (OMS) 100 according to an example of the subject matter described herein. Referring to FIG. 1, OMS 100 may include an OMS host server 102 that is communicatively connected to each of a design studio client 104, at least one web portal client 106, and an order management web service client 108. Notably, each of OMS host server 102 and clients 104-108 may comprise a special purpose computer device or machine that includes hardware components (e.g., one or more processor units, memory, and network interfaces) configured to execute software elements (e.g., applications, cartridges, modules, etc.) for the purposes of performing one or more aspects of the disclosed subject matter herein. In addition, it should be noted that OMS host server 102 and its components and functionality described herein constitute a special purpose computer that improves the technological field pertaining to order management systems by providing mechanisms for supporting start-start dependencies between order elements and/or for inferring dependencies in orchestration plans, e.g., during orchestration plan revisions where order elements are removed, added, or redone.

In some embodiments, design studio client 104 includes an OMS client machine that is provisioned with one or more cartridges 110. In particular, design studio client 104 may be configured to generate one or more cartridges 110 (e.g., software-based cartridges executable on one or more processors) that are compatible with an OMS host server. For example, cartridges 110 may include an order-to-activate (O2A) cartridge for performing various tasks and/or storing metadata associated with order-to-activate process in OMS 100, e.g., from order creation to service activation. In this example, O2A cartridge may include product specification definitions including fulfillment metadata (e.g., dependency relationships) and order line to fulfillment pattern mapping usable for generating orchestration plans. As used herein, cartridges 110 generated by design studio client 104 may include any software package, application, or module that is executable by a host server and contains configuration data that defines various policies (e.g., remedial operations and rules) for managing and/or generating orchestration plans associated with customer orders. Notably, the configuration data and associated metadata enables a recipient host server, such as OMS host server 102, to process, manage, and execute orders and/or generate and execute orchestration plans in accordance with the defined policies. After generating cartridges 110, design studio client 104 may be further configured to send cartridges 110 to OMS host server 102 for provisioning.

As indicated above, OMS 100 may include OMS host server 102, which is communicatively connected (e.g., via a local network or the Internet) to each of OMS clients 104-108. OMS clients 104-108 may represent various client entities that allow OMS operators or other users to communicate with OMS 100 or entities therein. For example, OMS clients 104-108 may allow users to send orders or related information to OMS host server 102 for processing.

In some embodiments, OMS host server 102 may include a processor 116 (which may be operatively coupled to a bus) for processing information and executing instructions or operations. Processor 116 may be any type of processor, such as a central processing unit (CPU), a microprocessor, a multi-core processor, and the like. OMS host server 102 further includes a memory 118 for storing information and instructions to be executed by processor 116. In some embodiments, memory 118 may comprise one or more of random access memory (RAM), read only memory (ROM), static storage such as a magnetic or optical disk, or any other type of machine or non-transitory computer-readable medium. OMS host server 102 may further include a communication device (not shown), such as a network interface card or other communications interface, configured to provide communications access to clients 104-108. In some embodiments, memory 118 may be utilized to store an order processing engine (OPE) 120, order cache 122, a model entity cache 124, and an orchestration plan cache 126.

In some embodiments, OMS host server 102 may receive a number of orders submitted from a client entity (e.g., OMS clients 104-108), either directly from the client entity or via an order capture system (not shown). For example, the received orders may comprise one or more central order management (COM) orders that identify one or more products and/or services (e.g., telecommunications services, network services, wireless communications services, etc.) requested by the client entity. In some embodiments, the order capture system may comprise a computer system configured to receive COM orders submitted by requesting client entities and to subsequently forward the orders to OMS host server 102 for processing. For example, OMS host server 102 may be configured to utilize OPE 120 to process the received COM orders.

Model entity cache 124 may represent any suitable entity (e.g., a storage device or memory) for storing order fulfillment metadata and/or modeled orchestration plans associated with cartridges 110 (e.g., O2A cartridge). For example, a modeled orchestration plan may be a static and/or pre-defined orchestration plan based on metadata, dependencies, and/or other information in cartridges 110. In this example, model entity cache 124 may include a number of modeled orchestration plans, where each modeled orchestration plan may represent an idealized order fulfillment plan with typical or standard dependencies between model order elements based on exemplary orders for tasks, services, or offers defined in cartridges 110.

Orchestration plan cache 126 may represent any suitable entity (e.g., a storage device or memory) for storing run-time orchestration plans and/or related information. For example, a run-time orchestration plan may be a dynamic orchestration plan based on a modeled orchestration plan, but may be augmented and/or modified to include or remove dependencies and/or order elements for representing an actual customer order submitted at run-time.

In some embodiments, OMS host server 102 may initially store the received orders in a data storage unit, such as a database (not shown). Afterwards, OMS host server 102 may employ OPE 120 to access the data storage unit to retrieve and store the COM orders in memory 118 (e.g., order cache 122). The orders contained in order cache 122 may then be processed by OPE 120 in accordance with relevant orchestration plans and/or using rules and policies set forth in model entity cache 124. In some embodiments, order cache 122 may contain any type of inbound and/or outbound order including, but not limited to customer orders, provisioning orders, billing orders, and inventory orders. Order cache 122 may also include COM orders, service order management orders (i.e., SOM orders), and/or other orders managed and processed by OMS host server 102.

In some embodiments, OPE 120 may represent any suitable entity or entities (e.g., a computing platform, software executing on a processor, a logic device, an ASIC, and/or an FPGA) for processing orders. For example, OPE 120 may be configured to process and manage several heterogeneous types of orders (i.e., different types of orders) stored in order cache 122. In some embodiments, OPE 120 may comprise a software algorithm (executable by one or more processors) that is configured to receive and process various types of orders.

In some embodiments, OPE 120 and/or another related entity (e.g., OMS host server 102) may generate an orchestration plan by determining one or more actions in a sequence necessary to complete an order. For example, OMS host server 102 may determine the requirements of an order and may identify order elements (e.g., one or more processes, tasks, actions, and/or various groupings therein) for fulfilling these requirements. In this example, OMS host server 102 may also determine an appropriate sequence for performing these order elements and may also determine one or more dependency relationships between these order elements.

For example, an orchestration plan may be for fulfilling a broadband Internet service order. In this example, the orchestration plan may include a sequence of order elements ‘A’, ‘B’, and ‘C’, where each order element may represent a task or a group of actions to be performed. Continuing with this example, order element ‘A’ may represent a task for shipping user equipment (e.g., a broadband modem) to the customer, order element ‘B’ may represent a task for installing the user equipment, and order element ‘C’ may represent a task for activating user equipment.

In some embodiments, OPE 120 and/or another related entity (e.g., OMS host server 102) may generate a run-time orchestration plan based on a modeled orchestration plan. For example, OPE 120 and/or another related entity may be configured to analyze a customer order and select a modeled orchestration plan from model entity cache 124 that can be modified or augmented to accurately represent fulfillment tasks for completing the customer order. In this example, after selecting a modeled orchestration plan, OPE 120 and/or another related entity may modify the modeled orchestration plan (e.g., by adding or removing order elements and/or dependencies between order elements) for generating a run-time orchestration plan representing fulfillment tasks for completing the customer order and may store the run-time orchestration plan in orchestration plan cache 126.

In some embodiments, OPE 120 and/or another related entity (e.g., OMS host server 102) may support various dependency relationships between order elements in an orchestration plan. Exemplary dependency relationships may include a complete-start dependency where a first order element is completed before a second order element is started, a data change dependency where a condition is met (e.g., an activity is completed, a data value is changed, or a value reaches a threshold) before a successor order element is started, and a start-start dependency where two order elements are to be started (but not necessarily completed) concurrently (e.g., in parallel, simultaneously, or nearly simultaneously).

In some embodiments, OPE 120 and/or another related entity (e.g., OMS host server 102) may allow users to specify additional requirements for orders, orchestration plans, or order elements therein. For example, a customer may indicate that two order elements are associated with a start-start dependency but that one order element should start and a slight delay (e.g., one hour) should occur before starting the second order element.

In some embodiments, OPE 120 and/or another related entity (e.g., OMS host server 102) may implement an orchestration plan (e.g., a run-time orchestration plan). For example, a run-time orchestration plan may include a plurality of order elements ‘A’, ‘B’, and ‘C’. In this example, the orchestration plan may indicate that the order elements are to be performed in a sequence, A→B→C, where adjacent order elements ‘A’ and ‘B’ have a complete-start dependency relationship and order elements ‘B’ and ‘C’ have a complete-start dependency relationship. Continuing with this example, OPE 120 and/or OMS host server 102 may perform or initiate performing various actions (e.g., communicating with other entities, compiling data, scheduling workforce, allocating resources, generating a shipping slip, etc.) such that each order element (or tasks therein) in the orchestration plan is completed, thereby completing the order.

In some embodiments, OPE 120 and/or another related entity (e.g., OMS host server 102) may support a variety of processing modes (e.g., task execution modes) for implementing orchestration plans or portions therein. For example, OPE 120 and/or another related entity (e.g., OMS host server 102) may include a DO mode, an UNDO mode, a REDO mode, and an AMEND-DO mode. In this example, a DO mode may be for a normal processing phase or base order processing, an UNDO mode may be for removing an order element or negating actions therein from an orchestration plan, a REDO mode may be for an amendment processing phase and may include reprocessing an order element, e.g., based on revised requirements from a customer, and an AMEND-DO mode may be for an amendment processing phase and may include processing an order element that has been added to an in-progress orchestration plan, e.g., based on revised requirements from a customer.

In some embodiments, OPE 120 and/or another related entity (e.g., OMS host server 102) may support start-start dependencies for an orchestration plan by maintaining state for each order element in the orchestration plan. For example, OPE 120 may maintain a state flag or value for each order element for determining whether the order element is “created”, “started”, “delayed”, or “resolved”. In this example, OPE 120 may use dependencies and current state values of predecessor (e.g., preceding) order elements for determining whether a successor (e.g., subsequent) order element is to be started.

In some embodiments, OPE 120 and/or another related entity (e.g., OMS host server 102) may modify (e.g., revise) an orchestration plan. In such embodiments, an in-progress order and/or a related orchestration plan may be revised to include an order element, remove an order element, redo an order element, and/or otherwise support start-start dependencies. For example, a customer may submit (e.g., via a client 108) an order to OMS host server 102 for a low-tier broadband internet service. In this example, the order may be known as a base order. A short time later, the customer may revise the order to request a higher-tier broadband internet service. OMS host server 102 may generate a new or revised version of the base order, called a revision order, containing the updated requirements. OMS host server 102 may compare the data in the revision order with the data in the base order and makes changes as indicated by the orchestration plan associated with the order, thereby allowing the base order to continue processing with, and compensating for, modifications indicated by the revision order.

In some embodiments, OPE 120 and/or another entity (OMS host server 102) may be configured to utilize a dependency inference algorithm and/or dependency detection logic (e.g., inferred dependency rules) for determining inferred dependencies between order elements. For example, a revision order may involve one or more order elements being removed or added in a current orchestration plan (e.g., an orchestration plan currently being implemented or in-progress). In this example, a dependency inference algorithm and/or dependency detection logic may be usable to generate or determine dependencies between related (e.g., sequential) order elements where dependencies are not explicitly provided by an OMS operator or user.

In some embodiments, OPE 120 and/or another entity (OMS host server 102) may be configured to communicate with an OMS operator or user. For example, OMS clients 104-108 may include functionality for receiving and displaying an orchestration plan, including known and/or inferred dependencies, graphically to a user. In this example, to indicate multiple types of dependencies in an orchestration plan, OMS host server 102 may use different colors and/or other mechanisms for accurately and/or efficiently displaying the orchestration plan and related dependency information.

In some embodiments, redundant dependencies (e.g., of the same dependency type and between the same order elements) may be marked, emphasized, shown graphically, ignored, de-emphasized, or not shown graphically. For example, OMS host server 102 or OPE 120 may use a redundant dependency marking algorithm for determining whether a dependency in an orchestration plan is redundant. Exemplary rules or logic for determining whether a dependency is redundant may include determining that all (or most) data change dependencies are not redundant, determining that a complete-start dependency is redundant if there is another longer path (e.g., between the two relevant order elements) that contains at least one complete-start dependency, and/or a start-start dependency is redundant if a longer path (e.g., between the two relevant order elements) exists.

It will be appreciated that FIG. 1 is for illustrative purposes and that various nodes, their locations, and/or their functions described above in relation to FIG. 1 may be changed, altered, added, or removed. For example, some nodes and/or functions may be combined into one entity, e.g., OPE 120 or some functionality therein may be integrated with OMS host server 102 or other entities associated with OMS 100.

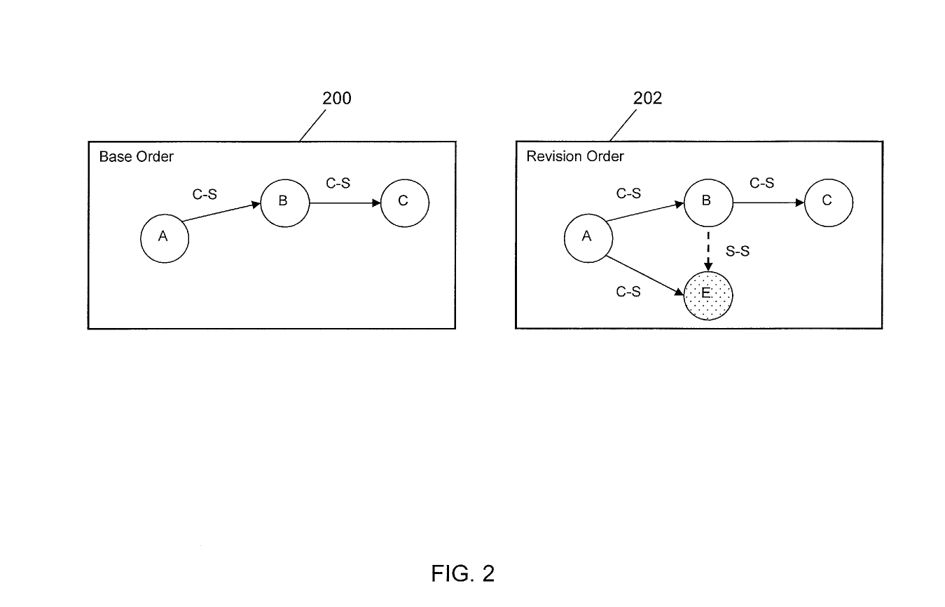

FIG. 2 is a diagram illustrating exemplary orchestration plans according to an example of the subject matter described herein. Referring to FIG. 2, base order 200 may represent an orchestration plan containing information usable for completing or fulfilling an order. As shown, base order 200 may include three order elements, represented by ‘A’, ‘B’, and ‘C’. Base order 200 may indicate a complete-start dependency between order element ‘A’ and order element ‘B’ and a complete-start dependency between order element ‘B’ and order element ‘C’.

In some embodiments, a revision order 202 may be received. For example, revision order 202 may be received via web portal client 106. Revised order 202 may represent a revised orchestration plan after order element ‘E’ is added to base order 200. As shown, a start-start dependency may exist between order element ‘B’ and order element ‘E’.

In some embodiments, OPE 120 and/or another entity (e.g., OMS host server 102) may determine when and/or how a newly added order element is processed, e.g., when an orchestration plan is revised or modified. For example, OPE 120 and/or another entity may support an intra-order start-start dependency by executing order elements within a same order concurrently if they are associated with a start-start dependency. In contrast, conventional OMS systems fail to execute order elements concurrently (e.g., in parallel) during an amendment (e.g., revision) processing phase

In some embodiments, OPE 120 and/or another entity may support start-start dependencies by implementing related amendment processing logic. Exemplary amendment processing logic may indicate that if a new order element (e.g., order element ‘E’ of revision order 202) is a successor of a start-start dependency, and its predecessor element (e.g., order element ‘B’ of revision order 202) is started or completed, then the new order element (or tasks therein) may be executed during an amendment processing phase. For example, assume in revision order 202 that order element ‘E’ is a new order element, that a start-start dependency exists between order element ‘E’ and order element ‘B’, and that revision order 202 is submitted when order element ‘B’ is completed in base order 200, OPE 120 may determine using amendment processing logic that order element ‘E’ and order element ‘B’ are to be started concurrently, e.g., by starting order element ‘B’ in a REDO mode and order element ‘E’ in an AMEND-DO mode. In contrast, using the same assumptions from the above example, a conventional OMS system would execute order elements ‘A’, ‘B’, and ‘C’, (e.g., in a REDO mode) and then execute order element ‘E’ (e.g., in a DO mode).

In another example illustrating amendment processing logic, assume in revision order 202 that order element ‘E’ is a new order element, that a start-start dependency exists between order element ‘E’ and order element ‘B’, and that revision order 202 is submitted when order element ‘C’ is completed in base order 200, OPE 120 may determine using amendment processing logic that order element ‘E’ will be executed, e.g., in an AMEND-DO mode. OPE 120 may also determine that if order element ‘A’ needs to be compensated (e.g., restarted, processed, executed, amended, revised, etc.), order element ‘E’ may be started (e.g., in an AMEND-DO mode) after order element ‘A’ is completed (e.g., in a REDO mode). OPE 120 may also determine that if order elements ‘B’ and/or ‘C’ needs to be compensated, order element ‘E’ may be started (e.g., in an AMEND-DO mode) concurrently with order element ‘B’ (e.g., in a REDO mode). OPE 120 may also determine that after order elements ‘E’, ‘B’, and ‘C’ complete compensation during an amendment processing phase, base order element processing (e.g., a non-amendment processing phase) may resume, e.g., subsequent order elements in base order 200 (not shown) may be started.

In yet another example illustrating amendment processing logic, assume in revision order 202 that order element ‘E’ is a new order element, that a start-start dependency exists between order element ‘E’ and order element ‘B’, and that revision order 202 is submitted when order element ‘B’ is completed in base order 200, OPE 120 may determine using amendment processing logic that order element ‘E’ will be executed, e.g., in an AMEND-DO mode. OPE 120 may also determine that if order element ‘A’ needs to be compensated, order element ‘E’ may be started (e.g., in an AMEND-DO mode) after order element ‘A’ is completed (e.g., in a REDO mode). OPE 120 may also determine that if order element ‘B’ does not need to be compensated (e.g., has no completed tasks), order element ‘E’ may be started (e.g., in an AMEND-DO mode) and order element ‘B’ will not be involved in compensation (e.g., will not be started in a REDO mode). OPE 120 may also determine that if order element ‘B’ needs to be compensated, order element ‘E’ may be started (e.g., in an AMEND-DO mode) concurrently with order element ‘B’ (e.g., in a REDO mode). OPE 120 may also determine that after order element ‘E’ and, if applicable, order element ‘B’ completes compensation during an amendment processing phase, base order element processing (e.g., a non-amendment processing phase) may resume, e.g., subsequent order elements in base order 200 (not shown) may be started.

In some embodiments, a start-start dependency may not influence execution sequence of predecessor and successor order elements during revision processing. For example, order elements that are associated with a start-start dependency may run or start in parallel, but there is no guarantee that tasks of a predecessor order element will be executed before tasks of a successor order element.

It will also be appreciated that exemplary base order 200 and revision order 202 are for illustrative purposes. Further, while the above examples are illustrative of some amendment processing logic that may be applied to order elements or tasks therein, it will also be appreciated that additional and/or different amendment processing logic or information may also be applicable when implementing a revised orchestration plan and/or processing order elements therein.

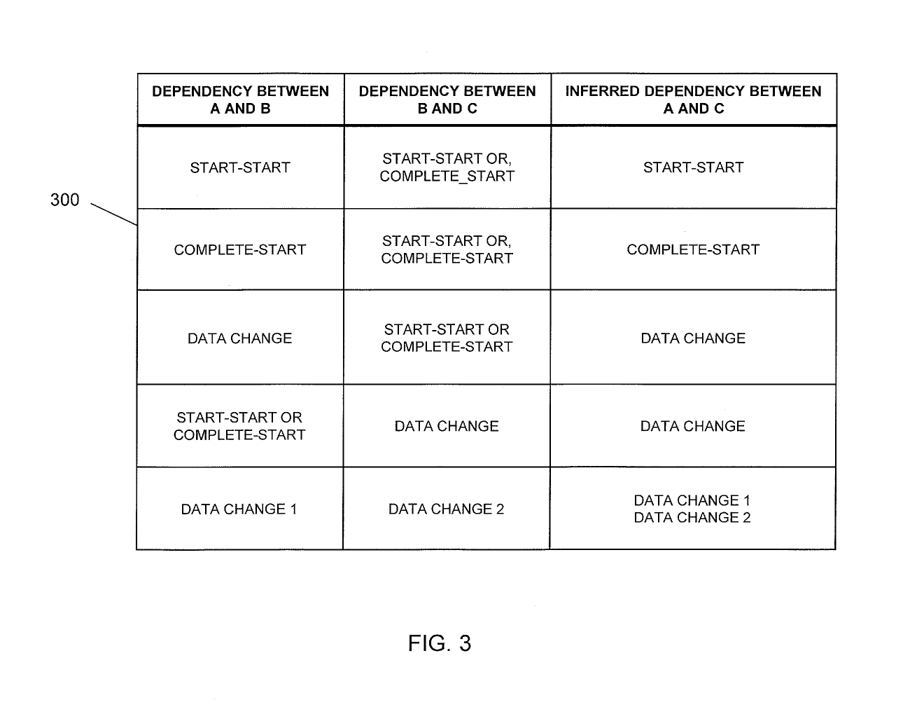

FIG. 3 is a diagram illustrating exemplary logic 300 for determining inferred dependencies according to an example of the subject matter described herein. Logic 300 may include any suitable information, such as and dependency information between order element ‘A’ and order element ‘B’, dependency information between order element ‘B’ and order element ‘C’, and/or inferred dependency information between order element ‘A’ and order element ‘C’, for determining inferred dependency relationships. In some embodiments, logic 300 may be preconfigured and/or provisioned by a manufacturer, OMS operator, and/or another entity. In some embodiments, logic 300 may be accessed by OMS 100, OMS host server 102, OPE 120, and/or another entity and may be stored using various data structures (e.g., in memory 118).

Referring to FIG. 3, logic 300 may represent dependency identification logic for determining inferred dependencies in various scenarios, e.g., orchestration plans involving three related (e.g., sequential or concurrent) order elements, where one order element (e.g., the “middle” or connecting order element) is removed in a revision order. In some embodiments, logic 300 may be stored using a multi-key lookup data structure such that an inferred dependency is based on two or more explicit dependencies.

As shown in FIG. 3, logic 300 may be depicted as a table having three columns. The table includes a first column, labeled in FIG. 3 as ‘DEPENDENCY BETWEEN A AND B’, for representing a dependency relationship type between a first order element and a second order element (e.g., order elements ‘A’ and ‘B’ of base order 200); a second column, labeled in FIG. 3 as ‘DEPENDENCY BETWEEN B AND C’, for representing a dependency relationship type between the second order element and a third order element (e.g., order elements ‘B’ and ‘C’ of base order 200); and a third column, labeled in FIG. 3 as ‘DEPENDENCY BETWEEN A AND C’, for representing an inferred dependency relationship type between the first order element and the third order element (e.g., order elements ‘A’ and ‘C’ of base order 200).

In some embodiments (e.g., when a second order element is removed in a revision order), OPE 120 may use logic 300, a known (e.g., explicit) dependency between a first order element and a second order element, and a known dependency between the second order element and a third order element in determining an inferred dependency between the first order element and the third order element. For example, using order elements ‘A’, ‘B’, and ‘C’ of base order 200, logic 300 may indicate an inferred dependency between order element ‘A’ and ‘C’, if order element ‘B’ is removed in a revision order.

Logic 300 depicted in FIG. 3 may be summarized below. If a start-start dependency exists between order element ‘A’ and order element ‘B’ and if a start-start or complete-start dependency exists between order element ‘B’ and order element ‘C’, then an inferred start-start dependency may exist between order element ‘A’ and order element ‘C’. If a complete-start dependency exists between order element ‘A’ and order element ‘B’ and if a start-start or complete-start dependency exists between order element ‘B’ and order element ‘C’, then an inferred complete-start dependency may exist between order element ‘A’ and order element ‘C’. If a data change dependency exists between order element ‘A’ and order element ‘B’ and if a start-start or complete-start dependency exists between order element ‘B’ and order element ‘C’, then an inferred data change dependency may exist between order element ‘A’ and order element ‘C’. If a start-start or complete-start dependency exists between order element ‘A’ and order element ‘B’ and if a data change dependency exists between order element ‘B’ and order element ‘C’, then an inferred data change dependency may exist between order element ‘A’ and order element ‘C’. If a first data change dependency exists between order element ‘A’ and order element ‘B’ and if a second data change dependency (e.g., a data change dependency having different data change condition(s) from the first data change dependency) exists between order element ‘B’ and order element ‘C’, then both data change dependencies may be inferred as existing between order element ‘A’ and order element ‘C’.

It will also be appreciated that exemplary logic 300 is for illustrative purposes and that different and/or additional data may be used for inferring dependencies associated with an orchestration plan and/or order elements therein. Further, it will be appreciated that logic 300 and/or related information may be usable for determining dependency for various types of orders, e.g., base orders and revision orders.

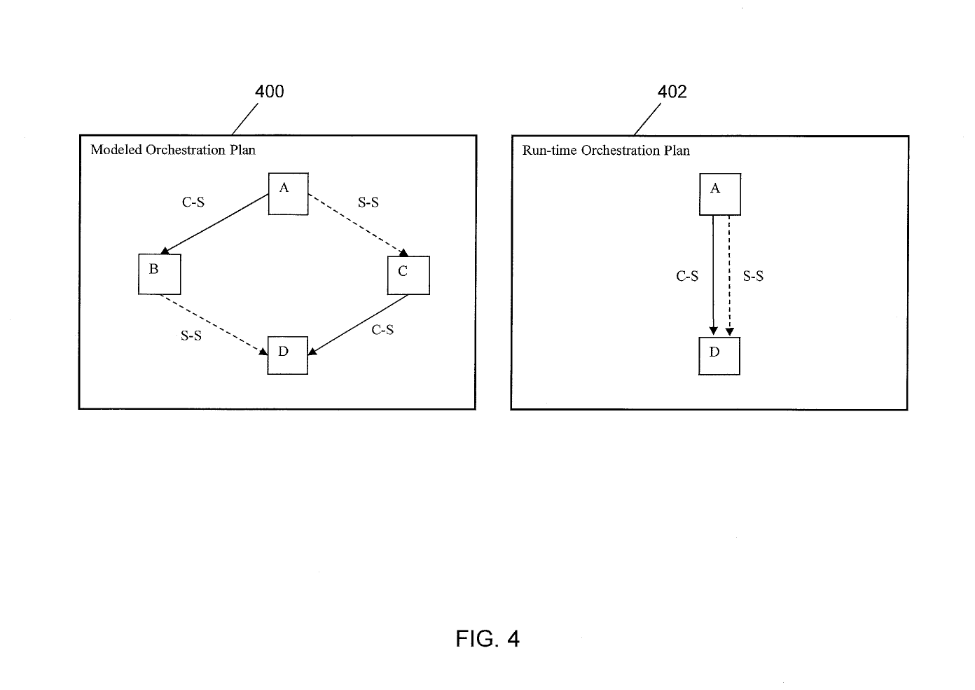

FIG. 4 is a diagram illustrating exemplary inferred dependencies according to an example of the subject matter described herein. In some embodiments, multiple inferred dependencies may be determined between two order elements. In such embodiments, OPE 120 and/or another entity may determine the inferred dependencies using logic 300 and/or other relevant information.

In some embodiments, OPE 120 and/or another entity may determine dependencies for various types of orders (e.g., base orders and revision orders). For example, OPE 120 may use logic 300 for determining inferred dependencies when implementing an orchestration plan for completing a customer order, e.g., implementing a run-time orchestration plan 402 based on a modeled orchestration plan 400. In another example, OPE 120 may use logic 300 for determining inferred dependencies when implementing a revised orchestration plan that includes additional order elements than an orchestration plan associated with a related base order. In another example, OPE 120 may use logic 300 for determining inferred dependencies when implementing a revised orchestration plan that involves removing one or more order elements existing in an orchestration plan associated with a related base order.

Referring to FIG. 4, modeled orchestration plan 400 may represent a static and/or pre-defined orchestration plan based on definitions and metadata associated with cartridges 110. As shown, modeled orchestration plan 400 may include four order elements, represented by ‘A’, ‘B’, ‘C’, and ‘D’, and may depict two paths between order element ‘A’ and order element ‘D’. A first path (A→B-D) in modeled orchestration plan 400 indicates a complete-start dependency between order element ‘A’ and order element ‘B’ and a start-start dependency between order element ‘B’ and order element ‘D’. A second path (A-C→D) in modeled orchestration plan 400 indicates that a start-start dependency between order element ‘A’ and order element ‘C’ and a complete-start dependency between order element ‘C’ and order element ‘D’.

Run-time orchestration plan 402 may represent a run-time orchestration plan that accurately represents fulfillment tasks for completing a customer order. For example, a customer order may be received via web portal client 106. In this example, OPE 120 and/or a related entity may select and modify modeled orchestration plan 400 to generate run-time orchestration plan 402 representing fulfillment tasks for completing the customer order.

As shown, run-time orchestration plan 402 includes order element ‘A’ and order element ‘D’ of modeled orchestration plan 400 with order element ‘B’ and order element ‘C’ of modeled orchestration plan 400 removed. Using a dependency inference algorithm and/or related logic, OPE 120 and/or another entity may determine two inferred dependencies between order element ‘A’ and order element ‘D’ when both order element ‘B’ and order element ‘C’ are eliminated. For example, using the dependencies associated with modeled orchestration plan 400 and logic 300, OPE 120 may determine a complete-start dependency between order element ‘A’ and order element ‘D’ for path (A→B-D) and a start-start dependency between order element ‘A’ and order element ‘D’ for path (A-C→D).

In some embodiments (e.g., where two order elements are associated with multiple dependencies), OPE 120 and/or another entity may be configured to start or delay actions associated with an order element until requirements associated with a dependency is met or fulfilled. For example, OPE 120 and/or another entity may implement the orchestration plan represented by run-time orchestration plan 402. In this example, the start-start dependency between order element ‘A’ and order element ‘D’ may have no effect on order processing, since OPE 120 and/or another entity may block or not initiate processing order element ‘D’ until order element ‘A’ completes as indicated by the complete-start dependency between order element ‘A’ and order element ‘D’.

In some embodiments, OPE 120 and/or another entity (e.g., OMS host server 102) may allow more than one dependency between two order elements (e.g., one of them may be referred to as the predecessor component and the other as the successor component). For example, some dependencies may be explicit dependencies that are modeled in cartridge 110 or using information in model entity cache 124 and other dependencies may be inferred dependencies that are determined by dependency identification logic. In this example, all dependencies for a predecessor order component are met (e.g., state of the dependencies become “resolved”) before the successor order component can be executed or started.

It will also be appreciated that exemplary modeled orchestration plan 400 and run-time orchestration plan 402 are for illustrative purposes. Further, while the above examples are illustrative of some inferred dependency logic that may be applied to order elements or tasks therein, it will also be appreciated that additional and/or different logic or information may also be applicable when implementing a run-time orchestration plan and/or processing order elements therein.

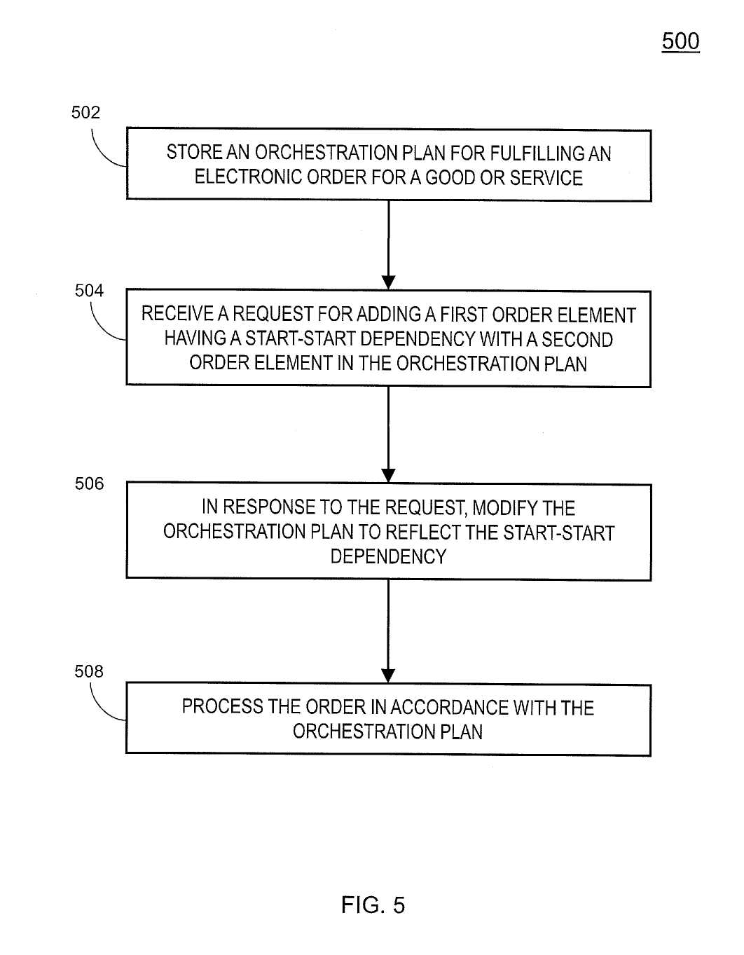

FIG. 5 is a flow chart illustrating an exemplary process 500 for processing an order having a start-start dependency according to an example of the subject matter described herein. In some embodiments, exemplary process 500, or portions thereof, may be performed by or at OMS 100, OPE 120, OMS host server 102, and/or another node, module, or entity. In some embodiments, exemplary process 500 may include steps 502, 504, 506, and/or 508.

At step 502, an orchestration plan for fulfilling an electronic order for a good or service may be stored in a memory. For example, an orchestration plan may be stored in memory 118 of OMS host server 102.

At step 504, a request may be received for adding a first order element having a start-start dependency with a second order element in the orchestration plan. For example, the request may be from a human user via one or more OMS clients 104-108 or related communications interfaces.

At step 506, in response to the request, the orchestration plan may be modified to reflect the start-start dependency.

At step 508, the order may be processed in accordance with the orchestration plan.

In some embodiments, processing an order in accordance with a modified orchestration plan includes determining, using amendment processing logic and a start-start dependency between a first order element and a second order element, whether the first order element is to be started in an amendment processing phase separate from a normal processing phase.

In some embodiments, determining that a first order element is to be started in an amendment processing phase includes determining that a second order element has been started or completed in an amendment processing phase.

In some embodiments (e.g., after an orchestration plan containing a start-start dependency between the first order element and the second order element is generated and/or in-progress), a request may be received for removing an existing order element from an orchestration plan. It may be determined, using dependency identification logic and a start-start dependency between a first order element and a second order element, at least one dependency (e.g., a start-start dependency) in the orchestration plan. The orchestration plan may be modified to reflect the at least one dependency and the order may be processed in accordance with the orchestration plan.

In some embodiments, modifying an orchestration plan to reflect a start-start dependency may include determining, using dependency identification logic (e.g., inferred dependency rules) and a start-start dependency between a first order element and a second order element, at least one dependency in the orchestration plan. For example, OPE 120 may use inferred dependency logic, such as logic 300, and/or related inferred dependency rules in determining that an inferred dependency exists between two order elements of a run-time orchestration plan.

In some embodiments, at least one dependency may include a complete-start dependency, a data change dependency, or start-start dependency between two order elements. For example, an orchestration plan having a first order element, a second order element, and a third order element may be revised to remove the second order element. In this example, the dependency may be based on a first dependency between the first order element and the second order element and a second dependency between the second order element and the third order element.

In some embodiments, at least one dependency may include two or more dependencies, e.g., between two order elements.

In some embodiments, redundant dependencies of a same type between two order elements may be identified via a user interface. For example, OPE 120 may use a redundant dependency marking algorithm for determining whether a dependency in an orchestration plan is redundant and, if so, emphasis or de-emphasis the redundancy.

It will also be appreciated that exemplary process 500 is for illustrative purposes and that different and/or additional actions may be used. It will also be appreciated that various actions associated with exemplary process 500 may occur in a different order or sequence.

It will be appreciated that OMS 100, OMS host server 102, OPE 120 and/or functionality described herein may constitute a special purpose computer. Further, it will be appreciated that OMS 100, OMS host server 102, OPE 120 and/or functionality described herein can improve the technological field pertaining to order management systems by providing mechanisms for supporting start-start dependencies between order elements and/or for inferring dependencies in orchestration plans, e.g., during orchestration plan revisions where order elements are removed, added, or redone.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for processing an order with a start-start dependency, the method comprising:
in an order management server that implements an electronic order management system, the order management server including at least one processor and a memory:
storing, in the memory of the order management server, an orchestration plan for fulfilling an electronic order for a good or service;
receiving, by the order management server, a request for adding a first order element having a start-start dependency with a second order element in the orchestration plan;
in response to the request, modifying, by the order management server, the orchestration plan to reflect the start-start dependency; and
processing, by the order management server, the order in accordance with the orchestration plan.

2. The method of claim 1 comprising:
receiving, by the order management server, a second request for removing an existing order element from the orchestration plan;
determining, using dependency identification logic and the start-start dependency between the first order element and the second order element, at least one dependency in the orchestration plan;
modifying, by the order management server, the orchestration plan to reflect the at least one dependency; and
processing, by the order management server, the order in accordance with the orchestration plan.

3. The method of claim 2 wherein the existing order element includes the first order element, the second order element, or a third order element.

4. The method of claim 1 wherein modifying the orchestration plan to reflect the start-start dependency includes determining, using dependency identification logic and the start-start dependency between the first order element and the second order element, at least one dependency in the orchestration plan.

5. The method of claim 4 wherein the at least one dependency includes a complete-start dependency, a data change dependency, or start-start dependency between two order elements.

6. The method of claim 5 wherein one of the two order elements includes the first order element, the second order element, or a third order element.

7. The method of claim 1 wherein processing the order in accordance with the orchestration plan includes determining, using amendment processing logic and the start-start dependency between the first order element and the second order element, whether the first order element is to be started in an amendment processing phase separate from a normal processing phase.

8. The method of claim 7 wherein determining that the first order element is to be started in the amendment processing phase includes determining that the second order element has been started or completed in the amendment processing phase.

9. The method of claim 1 comprising:
identifying, via a user interface, redundant dependencies of a same type between two order elements.

10. A system for processing an order with a start-start dependency, the system comprising:
at least one processor;
a memory; and
an order management server (OMS) that implements an electronic order management system, the order management server including the at least one processor and the memory, wherein the OMS is configured to store, in the memory of the OMS, an orchestration plan for fulfilling an electronic order for a good or service, to receive a request for adding a first order element having a start-start dependency with a second order element in the orchestration plan, in response to the request, to modify the orchestration plan to reflect the start-start dependency, and to process the order in accordance with the orchestration plan.

11. The system of claim 10 wherein the order management server is configured to receive a second request for removing an existing order element from the orchestration plan, to determine, using dependency identification logic and the start-start dependency between the first order element and the second order element, at least one dependency in the orchestration plan, to modify the orchestration plan to reflect the at least one dependency, and to process the order in accordance with the orchestration plan.

12. The system of claim 11 wherein the existing order element includes the first order element, the second order element, or a third order element.

13. The system of claim 10 wherein the order management server is configured to determine, using dependency identification logic and the start-start dependency between the first order element and the second order element, at least one dependency in the orchestration plan.

14. The system of claim 13 wherein the at least one dependency includes a complete-start dependency, a data change dependency, or start-start dependency between two order elements.

15. The system of claim 14 wherein one of the two order elements includes the first order element, the second order element, or a third order element.

16. The system of claim 10 wherein the order management server is configured to determine, using amendment processing logic and the start-start dependency between the first order element and the second order element, whether the first order element is to be started in an amendment processing phase separate from a normal processing phase.

17. The system of claim 16 wherein the order management server is configured to determine that the first order element is to be started in the amendment processing phase in response to determining that the second order element has been started or completed in the amendment processing phase.

18. The system of claim 10 wherein the order management server is configured to identify, via a user interface, redundant dependencies of a same type between two order elements.

19. A non-transitory computer readable medium having stored thereon executable instructions that when executed by a processor of a computer cause the computer to perform steps comprising:
storing an orchestration plan for fulfilling an electronic order for a good or service;
receiving a request for adding a first order element having a start-start dependency with a second order element in the orchestration plan;
in response to the request, modifying the orchestration plan to reflect the start-start dependency; and
processing the order in accordance with the orchestration plan.

20. The non-transitory computer readable medium of claim 19 comprising:
receiving a second request for removing an existing order element from the orchestration plan;
determining, using dependency identification logic and the start-start dependency between the first order element and the second order element, at least one dependency in the orchestration plan;
modifying the orchestration plan to reflect the at least one dependency; and
processing the order in accordance with the orchestration plan.
